(19) United States
(12) Patent Application Publication
(10) Pub. No.: US 2004/0035478 A1
(43) Pub. Date: Feb. 26, 2004

(54) Spherical seat inlet/exhaust valve

(76) Inventors: Robert J. Herbst, Avon, OH (US); Thanh Ho, Brunswick, OH (US); Duane R. Johnson, Wellington, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/227,933

(22) Filed: Aug. 26, 2002

(51) Int. Cl. F15B 13/042

(52) U.S. Cl. 137/627.5

(57) ABSTRACT

An inlet/exhaust valve having a cylindrical portion with a cavity therethrough for use in a pneumatic control valve is disclosed. The inlet/exhaust valve has at least two seats, one of which is on an inner diameter of the cylindrical portion and the other of which is on an outer diameter of the cylindrical portion. Both seats are rounded for self-aligning seating with corresponding seating surfaces.

### BACKGROUND OF THE INVENTION

The present invention relates to pneumatic flow control valves, and, more particularly, to inlet/exhaust valves used to assist in directing the pneumatic fluid.

Inlet/exhaust valves are conventionally used as poppet valves in pneumatic control valves to direct the pneumatic fluid. Conventional inlet/exhaust valves have rubber or bonded rubber face seal designs, which use a rubber seat to contact seating surface and provide an appropriate seal. These designs generally use an expensive bonding process to attach the rubber seat to the inlet/exhaust valve. Bonding processes can be unreliable and can only be checked for bond quality by destructive analysis.

Leakage and performance variations due to changes in temperature, contamination, and/or degradation of the rubber seat, are typical of these face seal designs for the inlet/exhaust valves. Moreover, the flow characteristics of these designs are generally turbulent, due to, among other things, flat seats and sharp turns in the airflow. This turbulence slows down the airflow through the valve.

The conventional designs usually require close guiding to ensure that the mating parts seat squarely in order to minimize leakage. The rubber seat designs also have an inherent hysteresis due to the compression of the rubber seat and the necessity for it to decompress prior to completely unseating.

### SUMMARY OF THE INVENTION

The present invention discloses a valve for use in an pneumatic brake system, including a housing having at least a supply port, a control port, a delivery port, and a exhaust port for flow of the pneumatic fluid therethrough. A piston in the housing responds to pressure from a control pneumatic fluid exerted via the control port to communicate with the inlet/exhaust poppet valve to selectively open and close the supply port, the delivery port, and exhaust port. The inlet/exhaust valve has a cylindrical portion with a cavity extending therethrough providing an inner diameter and an outer diameter. A first valve seat is formed on the outer diameter at a first end of the cylindrical portion and has a rounded seating surface, preferably spherical, and, most preferably, a convex surface. The inlet/exhaust valve has a second valve seat with a rounded seating surface, preferably spherical, and most preferably a concave surface, on the inner diameter of the cylindrical portion. The inlet/exhaust valve seats are rounded for self-alignment with corresponding seating surfaces with which they engage.

### BRIEF DESCRIPTION OF THE DRAWINGS

FIG. 1 is a cross-sectional representation of a conventional pneumatic control valve having an inlet/exhaust valve;

FIG. 2 is a cross-sectional view of an inlet/exhaust valve in accordance with the present invention;

FIG. 3 is an enlarged and separate view of the inlet/exhaust valve of FIG. 2; and

FIG. 4 is an enlarged detail view of the inlet/exhaust valve of FIG. 3.

### DETAILED DESCRIPTION OF THE PREFERRED EMBODIMENT

The present invention is described in relation to an air brake system such as used for heavy vehicles. While the invention has applications for this use, the invention is not limited to the specific embodiments herein described and the details of the preferred embodiments may be modified as warranted by other applications without departing from the spirit or scope of the invention. For example, while a preferred embodiment relating to pneumatic air brakes is detailed, the present invention may be used in any system for direction of a fluid through different flow paths. Use of the term “or” herein is the inclusive, and not the exclusive, use. See BRYAN A. GARNER, A DICTIONARY OF MODERN LEGAL USAGE 624 (2d Ed. 1995). The term “pneumatic fluid” as used herein means of or relating to use of a gas or liquid. The preferred pneumatic fluid is air.

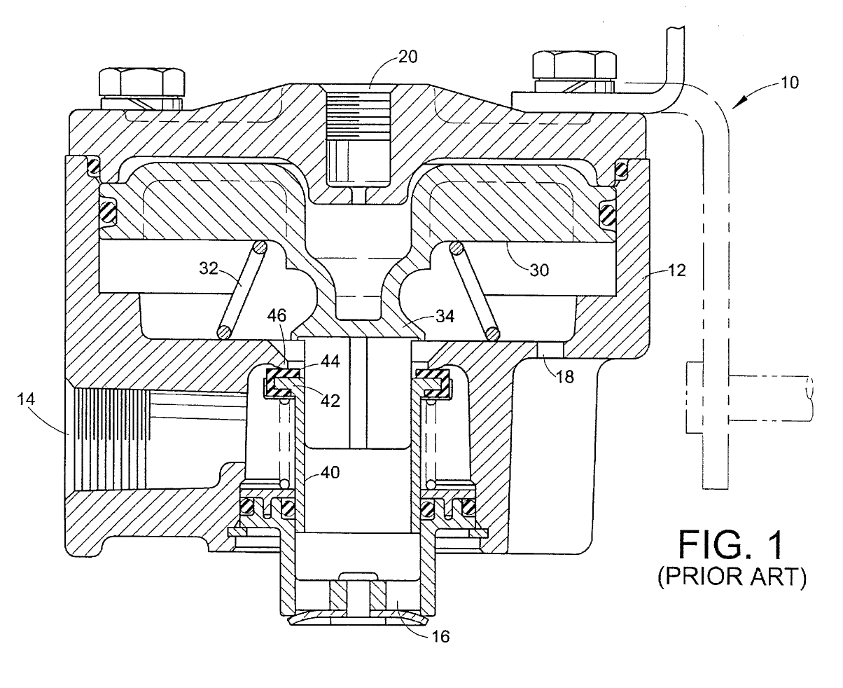

A conventional pneumatic control valve 10 of the type that is used in an air brake system for heavy vehicles is shown in FIG. 1. The pneumatic control valve 10 has a housing 12 that includes a supply port 14, an exhaust port 16, a delivery port 18, and a control port 20. A control signal is transmitted through the control port 20 and acts upon a piston 30 to move downwardly (as illustrated in FIG. 1—the actual direction will depend on the specific valve configuration selected by the user) against the force exerted by the pneumatic fluid in the delivery port 18. A differential spring 32 may be installed if, for example, there is a desire for additional differential pressure between the pressure of the fluid of the control port 20 and the pressure of the fluid of the delivery port 18. If there is no differential spring 18, then the force balance around piston 30 relative to the pressures exerted through the control port 20 and the delivery port 18 determine the movement and position of the piston 30. For this discussion, it will be presumed that the differential spring 32 is present, and the scope and spirit of the invention are not changed by the presence or absence of the differential spring 32.

The control signal may be actuated by depression of a brake pedal (not shown) and is generally transmitted via a control pneumatic fluid that may or may not be the same fluid as the pneumatic fluid for which the pneumatic control valve is designed to provide control. This urges an exhaust seat 34 into engagement with an inlet/exhaust valve 40.

The inlet/exhaust valve 40 includes a radial shoulder 42 on which is bonded a rubber seat 44. The engagement between the exhaust seat 34 and the rubber seat 44 precludes communication between the delivery port 18 and the exhaust port 16. Continued downward movement of the piston 30 moves the rubber seat 44 of the inlet/exhaust valve 40 from an associated seat 46 on the housing 12 and establishes communication between the supply port 14 and the delivery port 18. With this flow path open, pneumatic fluid is provided to the brake actuator or other pneumatic load through delivery port 18. Upon release of the control signal via control port 20, the return spring 32 (and the pneumatic fluid in the delivery port 18) exerts force upon the piston 30, moving it in an upward direction and allowing rubber seat 44 to again contact the associated seat 46 interrupting the flow path of pneumatic fluid from supply port 14 to delivery port 18. Further movement of the piston 30 in an upward direction in response to the change in force balance with the reduction in control pressure disengages exhaust seat 34 from rubber seat 44 and opens a flow path between delivery port 18 and exhaust port 16 such that pneumatic fluid is exhausted through exhaust port 16.

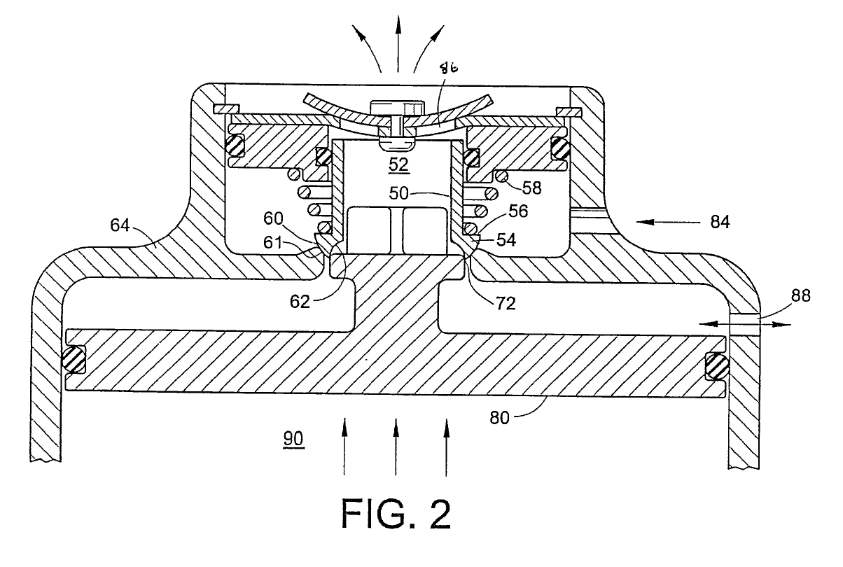

FIG. 2 illustrates an inlet/exhaust valve 50 in accordance with the present invention, which is generally cylindrical having a central passage 52 therethrough. A radially extending shoulder 54 is provided at one end with a face 56 that is engaged by a biasing spring 58 to urge the inlet/exhaust valve 50, and particularly a first or inlet seat 60, toward a first seating surface 61 on valve housing 64.

The first or inlet seat 60 of the inlet/exhaust valve 50 is rounded, preferably generally spheroidal, and, most preferably, is a convex surface. The first seating surface 61 is typically rounded, and the rounded first or inlet seat 60 sealingly seats against the rounded first seating surface 61.

As control pneumatic pressure is applied to the piston 80 via the control port 90, the piston 80 moves and engages the inlet/exhaust valve 50 at an exhaust seat 62 provided on the inner diameter of the inlet/exhaust valve 50 at second seating surface 72. The second seating surface 72 that engages the exhaust seat 62 is typically rounded, and preferably spherical, and the rounded second seating surface 72 sealingly engages the rounded exhaust seat 62 to interrupt the flow path of pneumatic fluid between the delivery port 88 and the exhaust port 86.

Upon further application of control pneumatic pressure on the surface of the piston 80, the piston 80 moves the inlet/exhaust valve 50 in an upward direction against the biasing force of biasing spring 58 the pneumatic fluid force acting on the inlet/exhaust valve 50 (upward as illustrated in FIG. 2—the actual direction will depend on the specific valve configuration selected by the user). This provides a flow path between the supply port 84 and the delivery port 88 such that pneumatic fluid may flow therethough.

Upon release of the control pressure signal from the control port 90 upon the piston 80, the biasing spring 58 exerts force against the face 56 and the delivery pressure acting on the opposite side of piston 80 move the inlet/exhaust valve 50 and the piston 80 in a downward direction such that inlet seat 60 again engages first seating surface 61, thus interrupting the flow path between supply port 84 and delivery port 88. The pressure from the delivery port 88 (and a differential spring, if present) further exerts a downward force on the piston 80 such that the second seating surface 72 disengages from the exhaust seat 62, providing a flow path between the delivery port 88 and exhaust port 86.

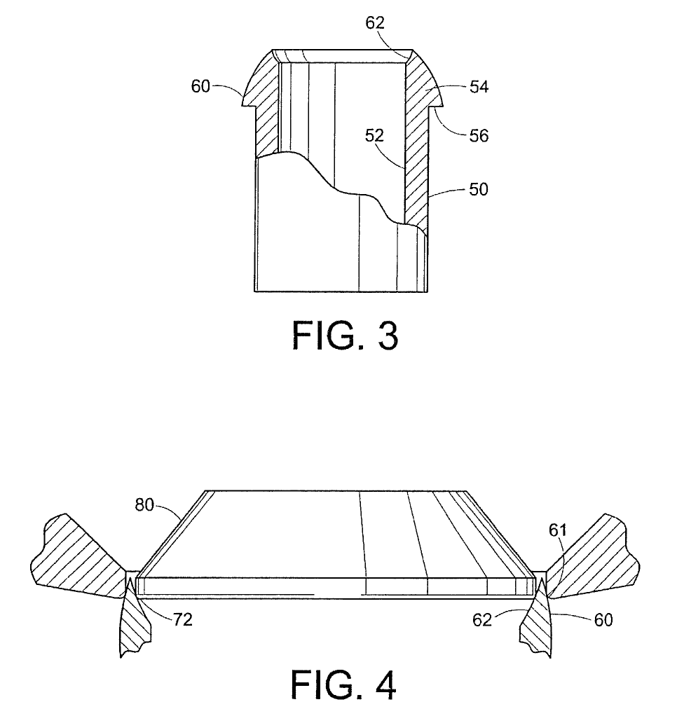

As shown in a preferred embodiment illustrated in FIGS. 2, 3, and 4, the first or inlet seat 60 and the second or exhaust seat 62 are provided at the same end of the inlet/exhaust valve 50. In other configurations, one of the inlet seat 60 and exhaust seat 62 may be provided at the opposite end of the inlet/exhaust valve 50, depending upon the configuration of the seating surfaces with which the seats shall engage, and depending upon the configuration of the remainder of the pneumatic control valve assembly. In other configurations, the seats 60, 62 may be located at any location along the cylinder, depending on the preference of the user and the circumstances of the specific application, including the specific configurations of the pneumatic control valve assembly. As shown on FIG. 3, preferably the first or inlet seat 60 is rounded, generally spherical, and of a convex shape. The second or exhaust seat 62 is preferably rounded, generally spherical, with a concave shape.

FIG. 4 illustrates the engagement between rounded inlet seat 60 and rounded first seating surface 61, as well as the engagement between rounded exhaust seat 62 and rounded second seating surface 72 of the piston 80. As illustrated in FIG. 4, when the piston 80 continues in a downward direction, the sealing seating between inlet seat 60 and first seating surface 61 will be interrupted, providing a flow path therethrough. As piston 80 travels in an upward direction in FIG. 4, then the sealing seating between rounded exhaust seat 62 and rounded second seating surface 72 will be interrupted providing a flow path therethrough.

The rounded configurations of inlet seat 60 and exhaust seat 62 allow for self-alignment of these seats with their respective seating surfaces 61, 72. No additional guide is necessary to ensure that the seats 60, 62 sealingly engage the seating surfaces 61, 72, because the rounded portion of the seats 60, 62 allow for self-aligning engagement of the rounded seating surfaces 61, 72 without the need for additional guides. These rounded configurations ensure seat sealing with a line contact seal when the parts are not perfectly aligned, which may result in a more uniform unit load.

The inlet/exhaust valve 50 is preferably a single piece, and most preferably, manufactured from plastic, but other configurations are contemplated, depending on the circumstances for each particular valve arrangement. A preferred method of making the inlet/exhaust valve 50 is by molding, such as injection molding of the plastic piece. The inlet/exhaust valve 50 may also be made from other materials, whether metallic or non-metallic, and may also be made such that the seating surfaces or the shoulder 54 are made from a different material as is the body of the inlet/exhaust valve 50. Elimination of the rubber seat 44 from the conventional inlet/exhaust valve, as shown in FIG. 1, reduces hysteresis due to compression of the rubber seat 44 and improves cold temperature performance over the conventional flat rubber seated valves. Moreover, use of a single-piece plastic inlet/exhaust valve enables a user to select a plastic to provide improved chemical resistance over the use of a rubber seat 44, thus extending the life of the part for those applications requiring improved chemical resistance.

While the present invention has been illustrated by the above description of embodiments, and while the embodiments have been described in some detail, it is not the intention of the applicants to restrict or in any way limit the scope of the invention to such detail. Additional advantages and modifications will readily appear to those skilled in the art. Therefore, the invention in its broader aspects is not limited to the specific details, representative apparatus and methods, and illustrative examples shown or described. Accordingly, departures may be made from such details without departing from the spirit or scope of the applicants' general or inventive concept.

We claim:

1. An inlet/exhaust valve assembly for directing the flow of a fluid comprising:
a cylindrical portion with a cavity extending therethrough and having an inner diameter and an outer diameter;
a first valve seat having a rounded seating surface on the outer diameter of the cylindrical portion; and
a second valve seat having a rounded seating surface on the inner diameter of the cylindrical portion.

2. The valve assembly of claim 1, wherein the first valve seat is at a first end of the cylindrical portion and the second valve seat is at the first end or at a second end of the cylindrical portion.

3. The valve assembly of claim 1, wherein the rounded seating surface of the first valve seat is generally convex.

4. The valve assembly of claim 1, wherein the rounded seating surface of the second valve seat is generally concave.

5. The valve assembly of claim 1, wherein the first and second valve seats are formed integrally with the cylindrical portion.

6. The valve assembly of claim 5, wherein the cylindrical portion and the integrally formed first and second valve seats are formed substantially of a plastic.

7. The valve assembly of claim 1, further comprising a shoulder extending substantially radially from a first end of the cylindrical portion, the shoulder having a face disposed to communicate with a biasing spring and a rounded segment defining a portion of the outer diameter.

8. The valve assembly of claim 7, wherein the first valve seat is disposed along the rounded segment of the shoulder.

9. The valve assembly of claim 1, wherein the first valve seat and the second valve seat are both at the first end of the cylindrical portion.

10. The valve assembly of claim 9, wherein the rounded seating surface of the first valve seat and the rounded seating surface of the second valve seat intersect.

11. A control valve for use in a directing a pneumatic fluid in a pneumatic system, comprising
a housing having at least a supply port, a control port, a delivery port, and an exhaust port;
a piston within the housing and in communication with the control port, the piston having at least one seating surface; and
an inlet/exhaust valve for communication with the piston, the inlet/exhaust valve having a cylindrical portion and at least a first inlet/exhaust valve seat and a second inlet/exhaust valve seat;
wherein the first and second inlet/exhaust valve seats are rounded for self-alignment with corresponding mating seating surfaces; and
wherein the communication between the piston and the inlet/exhaust valve determines the flow path for the fluid between the supply port and the delivery port and between the delivery port and the exhaust port.

12. The control valve of claim 11, wherein the corresponding mating seating surface for the first inlet/exhaust valve seat is formed integrally with the housing.

13. The control valve of claim 11, wherein the corresponding mating seating surface for the second inlet/exhaust valve seat is formed integrally with the piston.

14. The control valve of claim 11, wherein the first inlet/exhaust valve seat is generally convex.

15. The control valve of claim 11, wherein the second first inlet/exhaust valve seat is generally concave.

16. The control valve of claim 11, wherein the first and second inlet/exhaust valve seats are at one end of the cylindrical portion.

17. The control valve of claim 11, wherein the cylindrical portion has a central passage therethrough to provide a flow path for the fluid.

18. The control valve of claim 11 further comprising a first biasing spring for biasing the inlet/exhaust valve to interrupt a fluid flow path between the supply port and the delivery port.

19. The control valve of claim 18, wherein the inlet/exhaust valve comprises a radially extending shoulder having a face for communication with the first biasing spring.

20. The control valve of claim 11 further comprising a second biasing spring for biasing the piston to provide a fluid flow path between the delivery port and the exhaust port.
